(19) United States
(12) Patent Application Publication
(10) Pub. No.: US 2009/0104428 A1
(43) Pub. Date: Apr. 23, 2009

(54) Multi-layer film electrode structure and its preparation

(76) Inventors: Jen-Chieh Chung, Longtan Township (TW); Yu-Zhen Zeng, Longtan Township (TW); Yu-Chang Liu, Longtan Township (TW)

Correspondence Address: BRUCE H. TROXELL, SUITE 1404, 5205 LEESBURG PIKE, FALLS CHURCH, VA, 22041, US

(21) Appl. No.: 12/078,545

(22) Filed: Apr. 1, 2008

(30) Foreign Application Priority Data
Oct. 19, 2007 (TW) 096139096

(51) Int. Cl. B32B 3/26; B05D 5/12

(52) U.S. Cl. 428/318.6; 427/77

(57) ABSTRACT

The present invention discloses a multi-layer film electrode structure and a method preparing the same, the multi-layer film electrode comprises a substrate and three layers titania film formed from three kinds titania slurry having different properties; respectively, in which the first layer film is formed from fine titania slurry obtained by subjecting titanium alkoxide to a sol-gel reaction in an alcohol solvent, the second layer film is formed from a porous nanometer titania slurry obtained by subjecting titanium alkoxide to acidic hydrolysis in an alcohol solvent, and the third layer film is formed from a hybrid titania mixture slurry obtained by mixing the porous nanometer titania slurry with commercial available titania and metal oxide powder. The multi-layer film electrode structure of the present invention can enhance the adhesion between the titania film and the substrate and increase a light-power conversion efficiency of sensitive solar cell when it applies in solar cell field.

### FIELD OF THE INVENTION

The present invention relate to an electrode structure and a method for forming the same, more particularly to a multi-layer film electrode structure prepared by coating conductive substrate with various titania slurry having different properties.

### BACKGROUND OF THE INVENTION

Titania have been used widely in various industries including, for example, pigment, paper-making, paint, catalyst, sterilizing, cleaning, primer, waste water treatment fields, etc. Recently, titania has been applied in power scientific field with advancing high technology due to its unique semi-conductive properties. Titania is n-type semi-conductor and its molecular structure belongs to zinc blende lattice. According to crystal structure, titania can be classified into three major types, i.e. anatase, rutile and brookite. Generally, the crystal structure of titania is in an amorphous state at ambient temperature, in anatase type when calcined at a temperature between 200° C. to 500° C., in rutile type when calcined at a temperature between 500° C. to 600° C., and in brookite type when calcined at a temperature above 700° C. Crystal structure of anatase and rutile would change with temperature changing so that they are usually used in photo-catalysis reaction. Among them, for stability rutile is the best and for photo-reactivity anatase is the best. Thus, in field of energy industrial such as solar cell, anatase is the popular starting material.

In the past, most reports developed solar cell based on Group III-V elements. Also, Dr. Gratzel (Swiss Federal Institute of Technology Zurich) proposed a dye-sensitized solar cell (DSC) in 1990 (refer to U.S. Pat. No. 4,927,721(1990)) so that most scientists in the world are interesting to study heterogeneous photo-catalysis reaction. Such a solar cell structure is mainly consisting of the following essential components: (1) transparent conductive layers which are typically formed from indium tin oxide (ITO) and fluorine doped tin oxide (FTO) glass; (2) porous nanometer semi-conductive films which are used as electron conductive layer for sensitizing solar cell and are typically prepared by evenly coating porous nanometer titania slurry on a conductive glass; (3) dyes which have excellent light absorbability and stability and easily adsorb on the surface of titania; (4) electrolytes which must possess good redox reactivity and which key components are iodide ion (I⁻) and triiodide ion (I3⁻) although the electrolytes might have different compositions; and (5) counter electrode which is mainly formed from platinum currently.

The principle of dye sensitized solar cell is illustrated as below. Firstly, dye molecular absorbs solar light to generate electric charge separation; the separated electrons transfer to conduction band (CB) of a titania film through the dye molecular and then transfer to a counter electrode (usually a platinum electrode) via external lead, and then subject to redox reaction by using electrolyte I⁻ and I3⁻ so that the electron jump back to ground state of the dye to fill the hole. By repeating the above process, it forms a circulation. To enhance the light-power conversion efficiency of the dye-sensitized solar cell, the quality of titania film working electrode is important. The quality of titania film working electrode is dependent on the performances of titania slurry and its preparation. Generally, titania slurry used in dye-sensitized solar cell requires the properties of porous, high viscosity, and excellent adhesion to ITO conductive glass substrate, etc. To increase the solid content of titania suspension, U.S. Pat. No. 5,290,352(1994) disclosed a process for preparing titania slurry by directly wet-grinding industrial-grade titania dye with water to obtain a dye slurry having from 5 to 75% solid content. Moreover, U.S. Pat. No. 4,288,254(1981) disclosed a process for preparing rutile type titania pigment slurry having high solid content by wet grinding. In addition to rutile type titania pigment slurry, U.S. Pat. No. 6,197,104(2001) disclosed a process for preparing titania pigment slurry having a solid content of more than 75% by directly mixing anatase type titania with water, dispersant (such as acrylic acid) and minor single molecular substance (such as maleic acid, acrylamide, etc). In the processes disclosed in the above patents, the titania slurry is usually prepared by directly formulating commercial available titania. Such commercial available titania is obtained from titanium-containing mineral and contains titania particles having large particle size and a lot of impurity. Although commercial available titania can formulate titania pigment slurry having increased solid content, it is always used as raw material in industrial applications and is unsuitable for high technical energy industries which require high purity raw material. Additional, these patents are silent to the adhesion between titania pigment and ITO conductive glass substrate and its application in solar cell.

To utilize film working electrode effectively in a dye-sensitized solar cell, U.S. Pat. No. 5,084,365(1992) developed a nanometer titania slurry which is prepared by subjecting titanium alkoxide to a sol-gel reaction and then thickening at appropriate temperature and under pressure. Such slurry has advantages of high viscosity and porous property, but its preparation is complex and the raw material used is expensive.

There are usually two kinds processes for making nanometer titania powder. The first one is liquid phase synthesis and the second one is gas phase synthesis. The liquid phase synthesis ia further classified into the following two subtype: (1) sol-gel which comprises dissolving high purity metal alkoxide (M(OR)ₙ) or metal salt in a solvent such as water or alcohol and carrying out hydrolysis and condensation to form a gel having some spatial structure; (2) hydrolysis which comprises forcing hydrolysis of metal salt in solvents of different pH value to obtain a homogeneous dispersion of nanometer titania particles; (3) hydrothermal process which comprises reacting titania precursor in a sealed stainless container at a specified temperature and under pressure to obtain nanometer titania particles; (4) micro-emulsion process which comprises adding titania precursor into micro emulsion consisting of water and surfactant and reacting to form mono-dispersion of nanometer micell and then drying and calcining the resultant mono-dispersion.

The gas phase synthesis for preparing titania powder can be classified into the following subclasses: (1) chemical vapor deposition which comprises subjecting a titania precursor and oxygen to chemical vapor deposition to form a titania film or powder; (2) flame synthesis which comprises stream-heating metal compound by hydrogen-oxygen flame or acetylene-oxygen flame to induce chemical reaction and form nanometer particles; (3) vapor condensation which comprises vaporizing the starting material through vaporization under vacuum, heating or high frequency induction into gaseous or fine particles and then quickly chilling the gaseous or fine particles to collect the resultant nanometer powder; (4) laser ablation which comprises vaporizing a metal or non-metal target by using high energy laser beam and condensing the stream to obtain stable atom clusters from the gaseous phase.

However, the above processes for preparing titania are not exactly suitable in dye-sensitizing solar cell. In solar cell industries, a nanometer titania slurry which is porous, high viscosity, and high adhesion to substrate is most required. In recent study, it shows that a titania slurry prepared by sol-gel reaction possesses advantages of being porous and exhibiting excellent adhesion to ITO conductive glass substrate but also possesses a disadvantage of capable forming a film having a thickness of up to only 4 to 6 μm. Such a thickness could not satisfy with the requirement for a dye-sensitizing solar cell since the thickness of the titania film required to adsorb sufficient amount of dye and to impart the light:power conversion efficiency for the dye-sensitizing solar cell should be in a range of from 15 to 18 μm. It is important to increase the thickness of the titania film for enhancing the light-power conversion efficiency of a solar cell.

More recently, nanometer titania powder has been widely used in various industries and its required amount is increasing greatly. Therefore various processes for producing nanometer titania powder have been continuously developed so that the cost for obtaining nanometer titania powder from commercial source (for example P25 titania from Degussa) is decreasing. It is another selection to reduce the cost for producing titania film electrode by directly using commercial available nanometer titania powder. However, if the commercial available nanometer titania powder is directly used in formulating a titania slurry which is in turn coated on a substrate, the adhesion between the resultant titania film and the substrate is insufficient and thus its light-power conversion efficiency becomes worse. Therefore projects of how to increase the adhesion between a titania film and a substrate are continuously proposed. A process for forming a titania film on a substrate by directly using commercial available nanometer titania powder to formulate a titania slurry and then coating the titania slurry on a conductive substrate is proposed recently.

For example, U.S. Pat. No. 6,881,604 (2005) disclosed a process for preparing film electrode for solar cell, which comprises adding commercial available P25 titania powder (20% by weight) into volatile solvent (such as methanol, ethanol, or acetone) to formulate a titania slurry without adding binder, coating the titania slurry on a substrate, vaporizing the volatile solvent and pressing the substrate to form a titania film having a thickness of about 50 μm. Although the disclosed process resolve the problem of insufficient thickness of the titania film, it did not discuss about the adhesion between the titania film and the substrate. Furthermore, the adhesion between the titania film and the substrate is attributed by pressing the film-substrate without using the binder, the film is easily separated from the substrate and thus its light-power conversion efficiency becomes worse. Moreover, in addition to the film forming process by pressing, a process for form a film-substrate by sintering was also proposed in, for example, U.S. Pat. No. 5,569,561(1996); U.S. Pat. No. 5,084,365(1992); and U.S. Pat. No. 5,441,827(1995). Furthermore, U.S. Pat. No. 5,830,597(1998) disclosed a process for forming a film on a substrate by screen printing. U.S. Pat. No. 6,506,288(2003) disclosed a process for forming a titania film on a substrate by DC-sputtering.

### SUMMARY OF THE INVENTION

The present invention relates to a multi-layer titania film electrode structure and its preparation. The electrode is consisting of a substrate and three layers of titania coated on the substrate in which each layer possesses different properties; wherein the first layer is formed from nanometer titania slurry, the second layer is formed from porous titania slurry, and the third layer is formed from the porous titania slurry the same as the one used in the second layer but incorporated with various metal oxide powders.

According to the multi-layer titania film electrode structure and its preparation of the present invention, the first titania layer can improve the adhesion between the resultant film and the substrate while can serve as a barrier layer for preventing from circuit shorting. The second titania layer can facilitate the electron conductance and dye distribution due to the porous titania. The third titania layer can increase the thickness of the whole electrode and increase the amount of the dye adsorbed while can serve as a reflective layer due to the combination of the porous titania and metal oxide. By testing the preference of a cell incorporating with the multi-layer film electrode of the present invention, it demonstrated that the multi-layer film electrode of the present invention can exactly enhance the light-power conversion efficiency.

The present invention also relates to a method for forming a multi-layer film electrode structure, which can solve the problem of insufficient thickness associated with the electrode prepared by sol-gel process.

In one embodiment, the present invention provides a multi-layer film electrode structure, which comprises: a substrate; a titania-containing barrier layer, which is formed on the substrate and used for enhancing the light-power conversion efficiency of a cell; a titania-containing porous layer, which is formed on the titania-containing barrier layer and used for facilitating electron conductance and dye distribution; and

a titania-containing hybrid layer, which is formed on the titania-containing porous layer and used for increasing the thickness of the whole electrode structure and increasing the amount of the dye adsorbed while functions as a reflective layer.

In another embodiment, the present invention provides a method for forming a multi-layer film electrode structure, which comprises the steps of: providing a substrate; coating a titania slurry on the substrate and subjecting to a first treatment to form a titania film on the substrate; coating a porous nanometer titania slurry on the titania film and subjecting to a second treatment to form a porous titania film on the titania film; and coating a hybrid titania mixture slurry of porous nanometer titania and titania powder on the porous titania film subjecting to a third treatment to obtain the multi-layer film electrode structure.

### BRIEF DESCRIPTION OF THE DRAWINGS

The present invention is illustrated more detail by reference to the accompanying drawings, wherein:

FIG. 1 is a cross-section of the multi-layer film electrode structure of the present invention.

FIG. 2 is a flow chart showing the process for preparing titania slurry used for forming the titania-containing barrier layer in the present invention.

FIG. 3 is a flow chart showing the process for preparing the titania-containing porous layer in the present invention.

FIG. 4 is a flow chart showing the process for preparing the hybrid titania mixture slurry of porous nanometer titania and titania powder in the present invention.

FIG. 5 is a flow chart showing one embodiment of the method for forming the multi-layer film electrode structure of the present invention.

FIG. 6A is a flow chart showing the first treatment in the method for forming the multi-layer film electrode structure of the present invention.

FIG. 6B is a flow chart showing the second treatment in the method for forming the multi-layer film electrode structure of the present invention.

FIG. 6C is a flow chart showing the second treatment in the method for forming the multi-layer film electrode structure of the present invention.

FIG. 7 is a graph showing the light-power efficiency achieved by film electrode prepared from titania powder incorporated with 5% Degussa P25.

FIG. 8 is a graph showing the light-power efficiency achieved by film electrode prepared from titania powder incorporated with 10% Degussa P25.

### DETAILED DESCRIPTION OF THE INVENTION

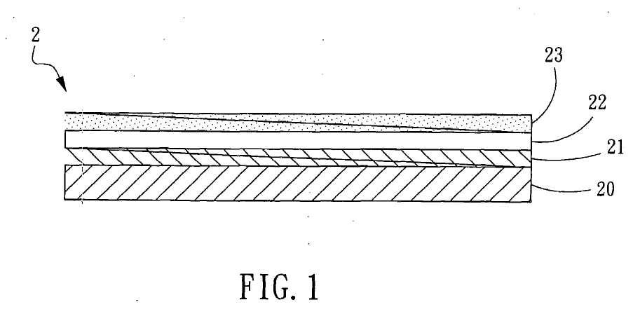

Please refer to FIG. 1, it is a cross-section of the multi-layer film electrode structure of the present invention. The multi-layer film electrode structure 2 comprises: a substrate 20, a titania-containing barrier layer 21, a titania-containing porous layer 22, and a titania-containing hybrid layer 23. The substrate 20 is a conductive substrate and is selected from indium tin oxide (ITO) conductive glass or fluoride tin oxide (FTO) conductive glass, but is not limited to those. The titania-containing barrier layer 21 is formed on the substrate 20 and used for enhancing the light-power conversion efficiency of a cell incorporated with the present electrode. In the present embodiment, the titania-containing barrier layer 21 is formed from material selected from the group consisting of titanium propoxide, titanium butoxide, titanium pentoxide, and a combination thereof. Furthermore, the titania-containing barrier layer 21 has a thickness in a range of from 1 to 6 μm, preferably from 2 to 4 μm.

The titania-containing porous layer 22 is formed on the titania-containing barrier layer 21 and used for facilitating electron conductance and dye distribution. The titania-containing porous layer 22 is formed from titania having a crystal structure of anatase and it has a thickness in a range of from 3 to 10 μm. The titania-containing hybrid layer 23 is formed on the titania-containing porous layer 22 and used for increasing the thickness of the whole electrode structure 2 and increasing the amount of the dye adsorbed while functions as a reflective layer.

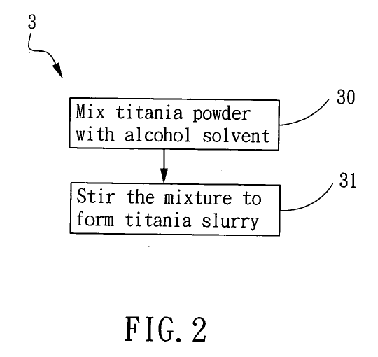

Now the method for forming the multi-layer film electrode structure of the present invention is illustrated. First at all, a process for preparing titania slurry used for forming the titania-containing barrier layer is illustrated. The titania slurry used for forming the titania-containing barrier layer is prepared by subjecting titanium alkoxide to sol-gel reaction in the presence of an alcohol solvent. Please refer to FIG. 2, the process 3 for preparing the titania slurry comprises the following steps: dissolving appropriate titanium alkoxide in the alcohol solvent (Step 30); then, mixing the resultant mixture for a period (e.g. 2 to 3 hours) to formulate a slurry solution having an appropriate concentration (Step 31).

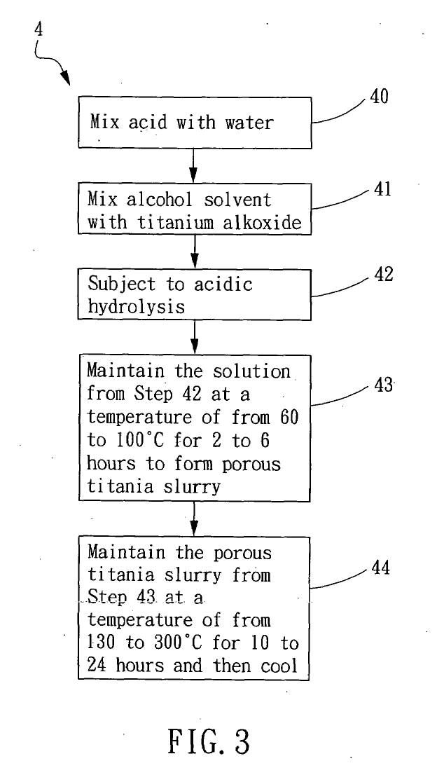

Next, a process for preparing porous nanometer titania slurry used for forming the titania-containing porous layer is illustrated. The process comprises the following steps: subjecting titanium alkoxide alcoholic solution to acidic hydrolysis by controlling the number of the alkyl group in the titanium alkoxide and the alcohol solvent and controlling the mole ratios of acid/titanium alkoxide and water/titanium alkoxide to obtain the porous nanometer titania slurry which has an appropriate viscosity and possesses excellent adhesion to the conductive substrate. Please refer to FIG. 3, the process 4 for preparing porous nanometer titania slurry used for forming the titania-containing porous layer comprises the following steps: mixing an acid and water (Step 40); mixing titanium alkoxide and an alcohol solvent (Step 41); and drops by drops adding the mixture obtained in Step 41 into the mixture obtained in Step 40 under a normal atmosphere or an inert gas to carry out acidic hydrolysis (Step 42); maintaining the solution obtained in Step 42 at a temperature of from 60 to 100° C. for 2 to 6 hours to form a titania slurry (Step 43); maintaing the titania slurry obtained in Step 43 at a temperature of from 130 to 300° C. for 10 to 24 hours and cooling (Step 44). The particle diameter of the titania particles in the slurry is in a range between 5 to 150 nm, preferably between 10 to 100 nm.

The sequence for carrying Steps 40 and 41 is not limited, Step 41 can be carried out before Step 40. Moreover, Steps 40 to 42 should be carried out at a temperature of from 3 to 10° C. In Step 42, the mixing acid/water solution and titanium alkoxide alcoholic solution should be carrired out under a normal atmosphere or an inert gas. The inert gas can use any inert gas as long as it has no influence on the reaction, for examples, nitrogen, argon gas, and the like.

In the method for forming the multi-layer film electrode structure of the present invention, the titanium alkoxide is a titanium alkoxide having 1 to 6 carbon atoms, for examples, titanium methoxide, titanium ethoxide, titanium propoxide, titanium isopropoxide, and titanium butoxide, and the like, among them, titanium ethoxide, titanium propoxide, and titanium butoxide are preferred. Furthermore, the alcohol solvent is an alkyl alcohol having 1 to 6 carbon atoms, for examples, methanol, ethanol, propanol, isopropanol, and butanol, and the like, among them, methanol, propanol, isopropanol, and butanol are preferred. The acid used in Step 40 can be organic acids or inorganic acids. The organic acid is alkanoic acid having 1 to 6 carbon atoms, for examples, formic acid, acetic acid, propionic acid, and the like. The inorganic acid includes, for example, nitric acid, sulfuric acid, hydrochloric acid, and the like. Moreover, in the process for preparing porous nanometer titania slurry used for forming the titania-containing porous layer, the mole ratio of water to titanium alkoxide is controlled in a range between 10 to 500, preferably between 10 to 300; the mole ratio of acid to titanium alkoxide is controlled in a range between 0.1 to 2, preferably between 0.1 to 1.

Next, a process for preparing the hybrid titania mixture slurry used for preparing the titania-containing hybrid layer is illustrated. The hybrid titania mixture slurry is prepared by mixing the above-mentioned porous nanometer titania slurry and commercial available titania powder and then incorporating with appropriate amount of metal oxide, for examples, Nb₂O₅ and Ta₂O₅, to formulate a hybrid titania mixture slurry, wherein the porous nanometer titania is contained in the mixture in an amount of 30 to 95% by weight, preferably from 60 to 90% by weight. The resultant hybrid titania mixture slurry provides much excellent adhesion to the conductive substrate than that obtained from commercial available titania powder.

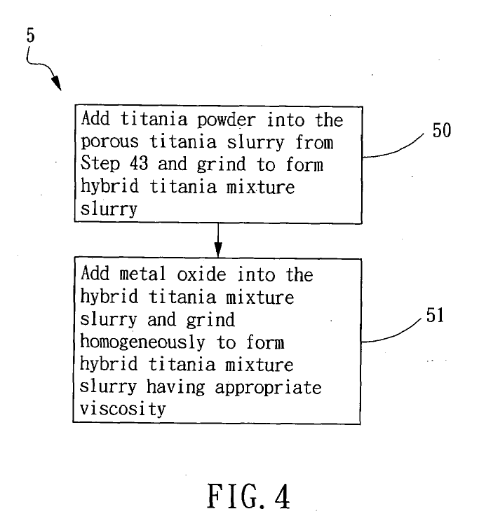

Please refer to FIG. 4, it shows a flow chart illustrating the process 5 for preparing the hybrid titania mixture slurry of a porous nanometer titania and a titania powder in the present invention. The process 5 comprises the following steps: adding commercial available titania powder into the porous nanometer titania slurry obtained in Step 43 and grinding to formulate a hybrid titania mixture slurry (Step 50); adding appropriate metal oxide into the hybrid titania mixture slurry obtained in Step 50 and blending uniformly to formulate a mixture slurry having an appropriate viscosity (Step 51).

In Step 50, a binder can further be added into the hybrid titania mixture slurry. The binder and its amount are not limited and easily determined by those skilled in the art depending on the kind of the commercial available titania powder and the used amount of the titania prepared in the present invention. Examples of the binder includes acetylacetone, polyethylene glycol having a molecular weight of 400 to 50000, Triton X-100, polyvinyl alcohol (PVA), acacia gum powder, gelatin powder, polyvinylpyrrolidine (PVP), and styrene, and the like, among them, acetylacetone, polyethylene glycol having a molecular weight of 400 to 50000, Triton X-100 are preferred. Moreover, a solvent can be used in Step 50, and its kind and amount are easily determined by those skilled in the art depending on the kind of the commercial available titania powder and the used amount of the titania prepared in the present invention, preferably water.

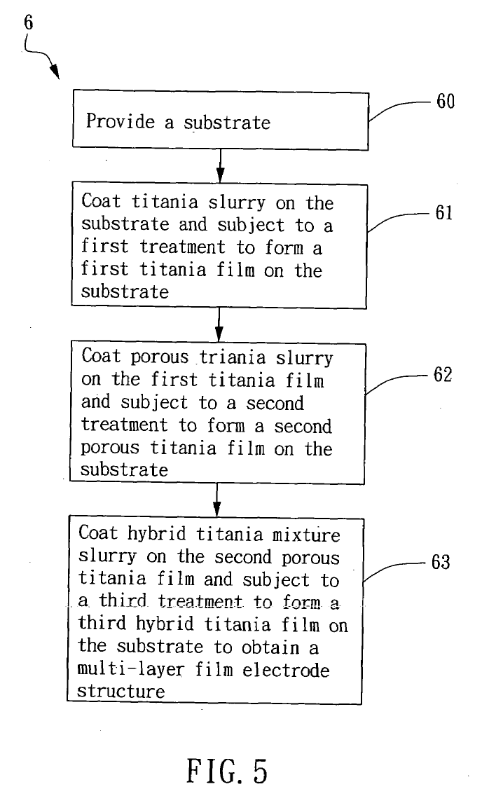

Please refer to FIG. 5. FIG. 5 is a flow chart showing one embodiment of the method for forming the multi-layer film electrode structure of the present invention. The method mainly uses the above-mentioned three different titania slurries to provide three layers having different properties. The method 6 comprises the following steps: providing a substrate (Step 60); coating a titania slurry onto the substrate and subjecting the substrate to a first treatment to form a titania-containing film on the substrate (Step 61); coating a porous nanometer titania slurry on the titania-containing film and subjecting the substrate to a second treatment to form a porous titania-containing film on the titania-containing film (Step 62); coating a hybrid titania mixture slurry of porous nanometer titania slurry and titania slurry on the porous titania-containing film and subjecting the substrate to a third treatment to form a hybrid titania-containing film on the porous titania-containing film (Step 63) to give the multi-layer film electrode structure of the present invention.

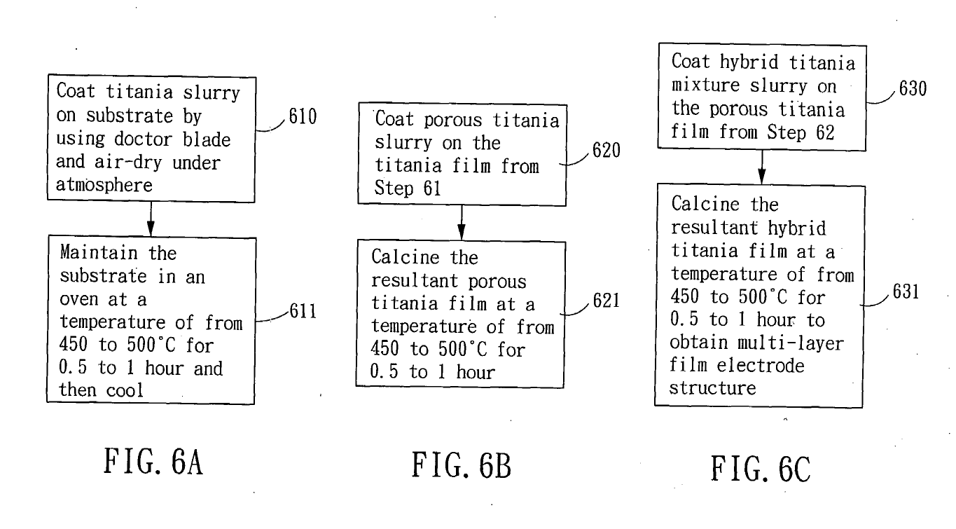

In the method for forming the multi-layer film electrode structure of the present invention, as shown in FIG. 6A, the first treatment in Step 61 further comprises the steps: coating the titania slurry directly on the substrate by doctor blade coating method and drying in the air (Step 610); maintaining the titania-coated substrate in an oven with slowly increasing the temperature to a range of from 450 to 500° C. for 0.5 to 1 hour and then cooling (Step 611) to obtain a fine and transparent nanometer titania film on the substrate.

The resultant titania film exhibit excellent adhesion to the substrate and can serve as a barrier layer. The thickness of the titania film is usually in a range of from 1 to 6 μm, preferably from 2 to 4 μm. The barrier layer can enhance the light-power conversion efficiency when used in a cell since the barrier layer can reduce its dark current. The titanium alkoxide used includes titanium propoxide, titanium butoxide, titanium pentoxide, and the like, among them, titanium butoxide is preferred. Further, the alcohol solvent used is an alkyl alcohol having 3 to 6 carbon atoms. Among them, propanol and butanol are preferred.

The slurry used in Step 61 is a fine particle titania slurry prepared by subjecting titanium alkoxide to sol-gel reaction in the alcohol solvent. It can be used as a barrier layer when formed on a conductive substrate and can resolve the problem of poor adhesion to the substrate associated with that prepared from only commercial available titania powder.

Moreover, as shown in FIG. 6B, the second treatment further the following steps: coating the porous titania slurry directly on the nanometer titania film obtained in Step 61 (Step 620); calcining the resultant substrate at a temperature of from 450 to 500° C. for 0.5 to 1 hour (Step 621) to obtain a porous titania film on the fine particle titania film having an average thickness of from 3 to 10 μm. The porous titania film exhibits excellent hardness and adhesion to the fine particle titania film. The porous titania film exhibits a hardness up to 6H order when tested by a pencil hardness test and exhibits excellent adhesion to the fine particle titania film. It helps the light-power conversion efficiency. The slurry in Step 62 is a porous titania slurry prepared by subjecting the titanium alkoxide to acid hydrolysis in an alcohol solvent. The porous titania slurry can enhance electron conduction and dye distribution when formed into a film.

Moreover, as shown in FIG. 6C, the third treatment further comprises the following steps: coating the hybrid titania mixture slurry on the porous titania film obtained in Step 62 (Step 630); and sintering the resultant substrate at a temperature of from 450 to 500° C. for 0.5 to 1 hour (Step 631) to obtain the multi-layer film electrode structure of the present invention.

The commercial available titania powder can be any titania powder without any limitation as long as it is a nanometer titania powder. Examples of the commercial available titania powder include, for example, Degussa P25, ISK STS-01, Hombikat UV-100, and the like. The hybrid titania mixture slurry used in Step 63 is prepared by mixing the titania slurry obtained in Step 62 and commercial available titania powder and metal oxide such as Nb₂O₅ to formulate a hybrid titania mixture slurry. When the hybrid titania mixture slurry is formed into an electrode, it can increase the thickness of the whole electrode and the amount of dye adsorbed while serves as a reflective layer. The above three different titania slurries are sequentially coated on a conductive substrate to form a film working electrode. The resultant titania films exhibit excellent adhesion to the substrate while increases its sensitivity to sun light and thus increase the light-power conversion efficiency when used in a solar cell.

In the method for forming the multi-layer film electrode of the present invention, coating of the titania slurry can use any coating method those skilled in the art without any limitation as long as it can achieve the desired thickness. Examples of the coating method include, for example, wet coating technique such as spin coating, doctor blade coating, dip coating, and those known in the art. Moreover, the thickness of the electrode shown in FIG. 5 is from 5 to 40 μm, preferably from 10 to 20 μm; particle size of the titania contained in the film is from 5 to 250 nm, preferably from 15 to 150 nm; and the hardness of the film is from 2B to 6H pencil hardness.

To understand the present invention clearly, the method for forming the multi-layer film electrode structure was illustrated by reference to following

### EXAMPLES

### Example 1

### Preparation of Fine Particle Titania Slurry and a Fine Titania Film

In a 30 mL Erlenmeyer flask, 1.36 grams titanium tetrabutoxide were added into 20 mL butanol. The flask was covered with a cap and stirred in a vibrator for at least 2 hours, preferably 3 hours to form homogeneous slurry. The resultant homogeneous slurry was evenly coated on a FTO conductive glass substrate by using a doctor blade and air-dried at room temperature for 3 to 8 hours, preferably 5 hours. Then the resultant substrate was calcined in an oven at a temperature of from 450 to 500° C. for 0.5 to 1 hour and cooled to room temperature to form a fine and transparent titania film on the FTO glass substrate. The film exhibited excellent adhesion to the substrate and had an average particle size of from 10 to 30 nm and a thickness of from 1 to 5 μm, preferably 2 to 3 μm.

### Example 2

### Preparation of Porous Nanometer Titania Slurry

10 mL isopropanol was mixed with 37 mL titanium ethoxide to form a isopropanol solution. Separately, in a 500 mL Erlenmeyer flask, 80 mL acetic acid was mixed with 250 mL distilled water to form an aqueous solution. The flask was placed into a thermostat at a constant temperature of about 5° C. The above isoproapnol solution was drops-by-drops added into the aqueous solution at a rate of about 2 drops/sec with constantly stirring over 1 hour. After completing the addition, the resultant solution became transparent. If there still remained as a suspension, the stirring time would be increased until the solution became transparent. The transparent solution was then placed in a thermostat at a temperature of 80° C. for 3 hours and then cooled. At this time, the solution became into a gel state. The gel solution was placed in an autoclave at a temperature of 190° C. for 12 hours and then cooled to room temperature to form a two-phase solution consisting of liquid phase and solid titania phase. The liquid phase was decanted out to leave the titania phase. The titania phase was further stirred to form titania slurry. The the titania slurry was found to have particle size of from 10 to 60 nm, an average particle size of 25 nm, a crystal structure of anatase, and a specific surface area of from 30 to 45 m²/g. The physical comparison of between the titania slurry of the present invention and other commercial available titania slurry was summarized in Table 1.

TABLE 1
Physical comparison of between the titania slurry of the present
invention and other commercial available titania slurry

| | | | Specific |
|---|---|---|---|
| Titania trade name | | Particle size | surface area |
| (Supplier) | Crystal structure | (nm) | (m²/g) |
| P25 powder | 75-85% anatase | 15-50 | 35-65 |
| (Degussa) | 15-25% rutile | | |
| ST2-02 (MC-150) | 100% anatase | 5 | 287 |
| powder | | | |
| (Ishihara) | | | |
| Ti-Nanoxide HT slurry | 100% anatase | 9 | 165 |
| (Solaronix SA) | | | |
| Titania powder | 100% anatase | 38 | 40 |
| (Alfa) | | | |
| Porous nanometer titania | 100% anatase | 10-60 | 30-45 |
| produced in the present | | | |
| invention | | | |

### Example 3

### Preparation of a Hybrid Titania Mixture Slurry of Porous Nanometer Titania and Commercial Available Titania Power and a Hybrid Titania Film

2 mL of the porous nanometer titania slurry prepared from Example 1 was added with P25 titania powder (commercial available from Degussa) and ground together for 10 to 20 minutes to form a hybrid titania mixture slurry wherein the P25 titania powder comprises 5 to 30% by weight, preferably from 10 to 20% by weight, of the hybrid titania mixture slurry. Then the hybrid titania mixture slurry was added with Nb₂O₅ or Ta₂O₅ powder and ground together for additional 10 to 20 minutes to form a homogeneous hybrid titania mixture slurry wherein the Nb₂O₅ or Ta₂O₅ powder comprises 1 to 10% by weight, preferably from 2 to 6% by weight, of the hybrid titania mixture slurry. The resultant homogeneous hybrid titania mixture slurry was evenly coated on a FTO conductive glass substrate by using a doctor blade and air-dried at room temperature for 3 to 8 hours, preferably 5 hours. Then the resultant substrate was calcined in an oven at a temperature of from 450 to 500° C. for 0.5 to 1 hour and cooled to room temperature to form a titania film on the FTO glass substrate. The film exhibited excellent adhesion to the substrate and had an average particle size of from 50 to 250nm and a thickness of from 5 to 15 μm, preferably 8 to 12 μm. Additionally, minor binder could also be added into the hybrid titania mixture slurry in amount of from 0 to 3% by weight, based on the total weight of the slurry. Examples of the binder include, for example, acetylacetone, polyethylene glycol having a molecular weight of from 400 to 50000, Triton X-100, polyvinyl alcohol (PVA), acacia gum powder, gelatin powder, polyvinylpyrrolidine (PVP), and styrene, and the like, among them, acetylacetone, polyethylene glycol having a molecular weight of from 400 to 50000, Triton X-100 are preferred.

### Example 4

### Preparation of Multi-Player Film Working Electrode and test of its Light-Power Conversion Efficiency

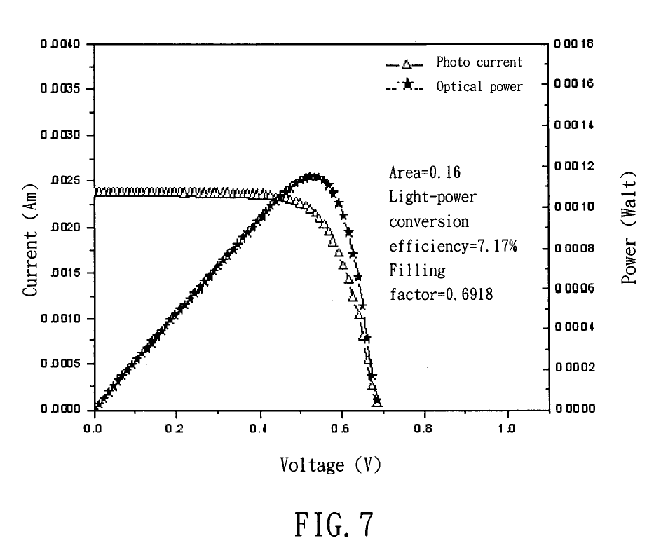

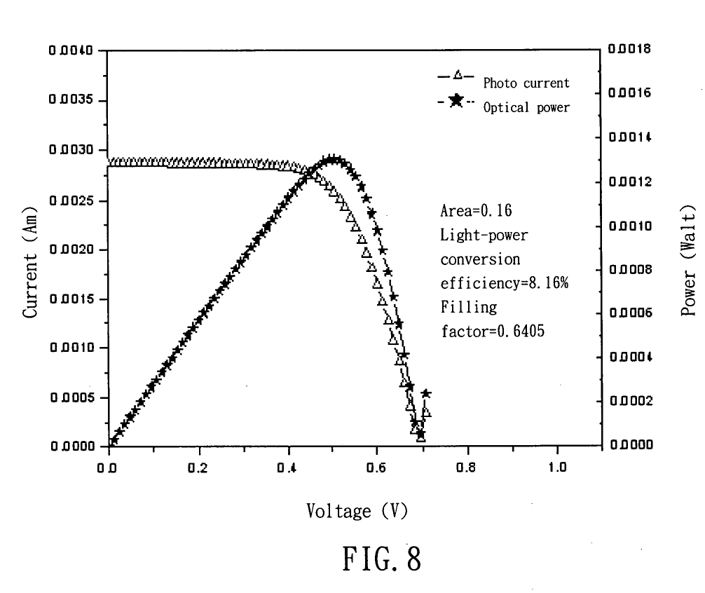

The homogeneous slurry prepared from Example 1 was evenly coated on a FTO conductive glass substrate by using a doctor blade and air-dried at room temperature for 3 to 8 hours, preferably 5 hours. Then the resultant substrate was calcined in an oven at a temperature of from 450 to 500° C. for 0.5 to 1 hour and cooled to room temperature to form a first fine and transparent titania film on the FTO glass substrate. Then the porous nanometer titania slurry prepared from Example 2 was evenly coated on the transparent titania film by using a doctor blade and air-dried at room temperature for 3 to 8 hours, preferably 5 hours. Then the resultant substrate was calcined in an oven at a temperature of from 450 to 500° C. for 0.5 to 1 hour and cooled to room temperature to form a second porous titania film on the FTO glass substrate. Finally, the hybrid titania mixture slurry prepared from Example 3 in which the P25 titania powder (Degussa) is in amount of either 5% or 10% by weight was evenly coated on the porous titania film by using a doctor blade and air-dried at room temperature for 3 to 8 hours, preferably 5 hours. Then the resultant substrate was calcined in an oven at a temperature of from 450 to 500° C. for 0.5 to 1 hour to form a third hybrid titania film on the FTO glass substrate. After the resultant substrate was cooled to 80° C., the substrate was immersed in 0.3 mM Ruthenium 533 dye solution for 2 hours and then dried to obtain a working electrode. The resultant working electrode was used as the anode, a platinum-plated FTO conductive glass substrate was used as the cathode, and an iodine-containing solution was used as electrolyte to constitute a cell. The cell was tested its light-power conversion efficiency (η) by using AM1.5 Solar simulator. The results are shown in Table 2 and FIGS. 7 and 8, in which FIG. 7 is the result of the working electrode having a third hybrid titania mixture slurry containing 5% by weight of P25 titania powder (Degussa) and its light-power conversion efficiency (η) was 7.17%, and FIG. 8 the result of the working electrode having a third hybrid titania mixture slurry containing 10% by weight of P25 titania powder (Degussa) and its light-power conversion efficiency (η) was 8.16%. The light-power conversion efficiency (η) of the multi-layer film electrode of the present is greatly increased than that of single layer film electrode.

TABLE 2
Properties of multi-player film working electrodes

| Multi-layer | | | | |
|---|---|---|---|---|
| film electrode | | | | light-power |
| (wt % of P25 | Photo | Photo | | conversion |
| titania powder | Current | Voltage | Filling | efficiency |
| in the third | I_{sc} | V_{oc} | Factor | (η) |
| layer) | (mA) | (V) | FF | (%) |
| The first/ | 2.38 | 0.70 | 0.69 | 7.17 |
| second/third | | | | |
| layers (5%) | | | | |
| The first/ | 2.88 | 0.71 | 0.64 | 8.16 |
| second/third | | | | |
| layers (10%) | | | | |

*AM1.5 Solar Test, Radiation area 0.16 cm², electrolyte solution was R150.

### Example 5

### Preparation of Working Electrode having Different Composition and Test of Their Light-Power Conversion Efficiency

The hybrid titania mixture slurry prepared from Example 3 in which the P25 titania powder (Degussa) is in amount of either 5% or 10% by weight was evenly coated on a FTO glass substrate by using a doctor blade and air-dried at room temperature for 3 to 8 hours, preferably 5 hours. Then the resultant substrate was calcined in an oven at a temperature of from 450 to 500° C. for 0.5 to 1 hour and then cooled to room temperature to form a single hybrid titania film on the FTO glass substrate. The substrate was immersed in 0.3 mM Ruthenium 533 dye solution for 2 hours and then dried to obtain a working electrode. The resultant working electrode was used as the anode, a platinum-plated FTO conductive glass substrate was used as the cathode, and an iodine-containing solution was used as electrolyte to constitute a cell. The cell was tested its light-power conversion efficiency (η) by using AM 1.5. Solar simulator.

Separately, a two-layer film working electrode was prepared similar to the process of Example 4 except using the fine titania slurry prepared from Example 1 to form a first layer film and using the hybrid titania mixture slurry prepared from Example 3 in which the P25 titania powder (Degussa) is in amount of either 5% or 10% by weight. The substrate was immersed in 0.3 mM Ruthenium 533 dye solution for 2 hours and then dried to obtain a working electrode. The resultant working electrode was used as the anode, a platinum-plated FTO conductive glass substrate was used as the cathode, and an iodine-containing solution was used as electrolyte to constitute a cell. The cell was tested its light-power conversion efficiency (η) by using AM 1.5 Solar simulator.

Separately, a three-layer film working electrode was prepared similar to the process of Example 4. The resultant working electrode was used as the anode, a platinum-plated FTO conductive glass substrate was used as the cathode, and an iodine-containing solution was used as electrolyte to constitute a cell. The cell was tested its light-power conversion efficiency (η) by using AM1.5 Solar simulator.

The results are summarized in Table 3. From the results in Table 3, it showed that for adding with 5% by weight of P25 titania powder, the light-power conversion efficiency (η) of the single layer film electrode (referred to Sample No. 1) is 3.24%, that of the two-layer film electrode(referred to Sample No. 2) is 5.11%, and that of the three-layer film electrode (referred to Sample No. 3) is 7.17%. For adding with 10% by weight of P25 titania powder, the light-power conversion efficiency (η) of the single layer film electrode (referred to Sample No. 4) is 3.80%, that of the two-layer film electrode (referred to Sample No. 5) is 6.78%, and that of the three-layer film electrode (referred to Sample No. 6) is 8.16%. It clearly showed that the light-power conversion efficiency (η) of the three-layer film electrode was increased 3 to 5% than the light-power conversion efficiency (η) of the single layer film electrode. Also, the light-power conversion efficiency (η) of the film electrode adding with 10% by weight P25 titania powder was increased 1% than that of the film electrode adding with 5% by weight P25 titania powder.

From the above results, the multi-layer film electrode of the present invention not only exhibits excellent adhesion between titania film and substrate but also greatly increase the light-power conversion efficiency when it is used in solar cell.

TABLE 3
Properties of multi-player film working electrodes

| | | | | light-power |
|---|---|---|---|---|
| | Photo | Photo | | conversion |
| | Current | Voltage | Filling | efficiency |
| | I_{sc} | V_{oc} | Factor | (η) |
| Sample No. | (mA) | (V) | FF | (%) |
| Sample No. 1 | 1.09 | 0.70 | 0.68 | 3.24 |
| Sample No. 2 | 1.73 | 0.71 | 0.67 | 5.11 |
| Sample No. 3 | 2.38 | 0.70 | 0.69 | 7.17 |
| Sample No. 4 | 1.35 | 0.67 | 0.68 | 3.80 |
| Sample No. 5 | 2.41 | 0.67 | 0.67 | 6.78 |
| Sample No. 6 | 2.88 | 0.71 | 0.64 | 8.16 |

*AM1.5 Solar Test, Radiation area 0.16 cm², electrolyte solution was R150.

While the present invention has been particularly shown and described with reference to exemplary embodiments thereof, it will be understood by those of ordinary skill in the art that various changes and modifications may be made therein without departing from the spirit and scope of the present invention as defined by the following claims.

What is claimed is:

1. A multi-layer film electrode structure, which comprises:
a substrate;
a titania barrier film, which is formed on the substrate and used for enhancing the light-power conversion efficiency of a cell;
a porous titania film, which is formed on the titania barrier film and used for facilitating electron conductance and dye distribution; and
a hybrid titania flim, which is formed on the porous titania film and used for increasing the thickness of the whole electrode structure and increasing the amount of the dye adsorbed while functions as a reflective layer.

2. The multi-layer film electrode structure according to claim 1, wherein the substrate is a conductive substrate.

3. The multi-layer film electrode structure according to claim 2, wherein the conductive substrate is one selected from ITO conductive glass and FTO conductive glass.

4. The multi-layer film electrode structure according to claim 1, wherein the titania barrier layer is prepared from the material selected from the group consisting of titanium propoxide, titanium butoxide, titanium pentoxide, and a combination thereof through a sol-gel reaction.

5. The multi-layer film electrode structure according to claim 1, wherein the titania barrier film has a thickness in a range of from 1 to 6 μm.

6. The multi-layer film electrode structure according to claim 1, wherein the titania contained in the porous titania film is anatase.

7. The multi-layer film electrode structure according to claim 1, wherein the porous titania film has a thickness in a range of from 3 to 10 μm.

8. A method for forming multi-layer film electrode structure, which comprises the steps of:
providing a substrate;
coating a titania slurry on the substrate and subjecting to a first treatment to form a titania film on the substrate;
coating a porous nanometer titania slurry on the titania film and subjecting to a second treatment to form a porous titania film on the titania film; and
coating a hybrid titania slurry mixture of porous nanometer titania and titania powder on the porous titania film and subjecting to a third treatment to obtain the multi-layer film electrode structure.

9. The method for forming multi-layer film electrode structure according to claim 8, wherein the titania slurry is prepared from titanium alkoxide through a sol-gel reaction in the presence of an alcohol solvent.

10. The method for forming multi-layer film electrode structure according to claim 9, wherein the alcohol solvent is an alkyl alcohol having 3 to 6 carbon atoms.

11. The method for forming multi-layer film electrode structure according to claim 10, wherein the alkyl alcohol solvent is propanol or butanol.

12. The method for forming multi-layer film electrode structure according to claim 8, wherein the first treatment further comprises the following steps:
air-drying the titania slurry coated on the substrate; and
placing the substrate having the air-dried titania film in an elevated temperature oven where the temperature is slowly increased to 450 to 500° C. for 0.5 to 1 hour and then cooling.

13. The method for forming multi-layer film electrode structure according to claim 8, wherein the porous nanometer titania slurry is prepared by the process comprising the following step:
acidic hydrolysis of titanium alkoxide in the presence of an acid in an alcohol solvent by controlling the number of the alkyl group in the titanium alkoxide and the alcohol solvent and controlling the mole ratios of acid/titanium alkoxide and water/titanium alkoxide to obtain the porous nanometer titania slurry.

14. The method for forming multi-layer film electrode structure according to claim 13, wherein the acidic hydrolysis further comprises the following steps:
(1) mixing an acid and water;
(2) mixing the alcohol solvent and the titanium alkoxide; and
(3) drops by drops adding the mixture solution obtained in the step (2) into the mixture solution obtained in the step (1) to subject to the acidic hydrolysis.

15. The method for forming multi-layer film electrode structure according to claim 14, which further comprises the steps of:
(4) maintaining the solution obtained in the step (3) at a temperature of from 60 to 100° C. for 2 to 6 hours to obtain titania slurry; and
(5) maintaining the titania slurry obtained in the step (4) at a temperature of from 130 to 300° C. for 10 to 24 hours and then cooling.

16. The method for forming multi-layer film electrode structure according to claim 13, wherein the mole ratio of water to titanium alkoxide is controlled in a range of from 10 to 500.

17. The method for forming multi-layer film electrode structure according to claim 13, wherein the mole ratio of acid to titanium alkoxide is controlled in a range of from 0.1 and 2.

18. The method for forming multi-layer film electrode structure according to claim 13, wherein the titanium alkoxide is titanium alkoxide having 1 to 6 carbon atoms.

19. The method for forming multi-layer film electrode structure according to claim 13, wherein the acid is an organic acid or an inorganic acid, and the organic acid is an alkanoic acid having 1 to 6 carbon atoms.

20. The method for forming multi-layer film electrode structure according to claim 13, wherein the alcohol solvent is an alcohol solvent having 1 to 6 carbon atoms.

21. The method for forming multi-layer film electrode structure according to claim 8, wherein the second treatment comprises calcining the substrate coated with the porous titania slurry in an oven at a temperature of from 450 to 500° C. for 0.5 to 1 hour.

22. The method for forming multi-layer film electrode structure according to claim 8, wherein the hybrid titania slurry mixture of the porous nanometer titania and titania powder further comprises a metal oxide.

23. The method for forming multi-layer film electrode structure according to claim 22, wherein the metal oxide is Nb₂O₅, Ta₂O₅, or a combination thereof.

24. The method for forming multi-layer film electrode structure according to claim 8, wherein the hybrid titania mixture slurry of the porous nanometer titania and titania powder further comprises a binder.

25. The method for forming multi-layer film electrode structure according to claim 24, wherein the binder is at least one selected from acetylacetone, polyethylene glycol having a molecular weight of from 400 to 50000, Triton X-100, polyvinyl alcohol (PVA), acacia gum powder, gelatin powder, polyvinylpyrrolidine (PVP), and styrene.

26. The method for forming multi-layer film electrode structure according to claim 8, wherein the porous nanometer titania is contained in the mixture in an amount of 30 to 95% by weight.

27. The method for forming multi-layer film electrode structure according to claim 8, wherein the third treatment comprises sintering the substrate coated with the mixture in an oven at a temperature of from 450 to 500° C. for 0.5 to 1 hour.
